(19) United States
(12) Patent Application Publication
(10) Pub. No.: US 2012/0072604 A1
(43) Pub. Date: Mar. 22, 2012

(54) TECHNIQUE FOR DELIVERING CONTENT TO A USER

(75) Inventors: Emile Stephan, Pleumeur Bodou (FR); Joel Lattmann, Champs Sur Marne (FR)

(73) Assignee: FRANCE TELECOM, Paris (FR)

(21) Appl. No.: 13/375,111

(22) PCT Filed: May 18, 2010
(86) PCT No.: PCT/FR10/50956

§ 371 Date: Nov. 29, 2011

(30) Foreign Application Priority Data
May 29, 2009 (FR) 0953566

(51) Int. Cl. G06F 15/16

(52) U.S. Cl. 709/228

(57) ABSTRACT

A technique is provided for delivering content to a user. The user sends at least one quality indicator to a first content-delivery device, referred to as a secondary device. The indicator relates to delivery of a portion of the content by a second content-delivery device, referred to as a primary device. When the secondary device detects an event that might affect the delivery of the content by the primary device to the user, on the basis at least of the quality indicators relating to at least a delivery of content by the primary device, it commands the user to transfer from the primary device to the secondary device in order to enable the secondary device to deliver portions of the content that have not been delivered by the primary device.

### CROSS-REFERENCE TO RELATED APPLICATIONS

This Application is a Section 371 National Stage Application of International Application No. PCT/FR2010/050956, filed May 18, 2010, which is incorporated by reference in its entirety and published as WO 2010/136699 on Dec. 2, 2010, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The disclosure relates to a technique for delivering a content to a user by content-delivery devices.

The disclosure lies in the fields of telecommunications, and more particularly in the field of content delivery.

### BACKGROUND OF THE DISCLOSURE

Techniques exist that enable the user of a terminal to obtain content from a content-delivery server. In order to guarantee that the content is available, it is possible to obtain content from a plurality of content-delivery servers in a communications network or from peers each having at least a portion of the content in a peer-to-peer (P2P) network. The terminal obtains data simultaneously from a plurality of servers or peers. The potential redundancy introduced by such servers or such peers enables the actual availability of the content to be increased. For example, it may be appropriate to vary the number of servers or of peers involved in the distribution of the content in order to deliver some given level of quality. This given level of quality is desired but it is not guaranteed. Furthermore, it is difficult to measure quality, whether network quality or quality as experienced by the user, since a plurality of servers are involved in delivering the content. In addition, a decision is taken only in response to measuring low levels of quality. The user thus perceives the drop in quality and is not satisfied.

### SUMMARY

In a first aspect, an embodiment of the invention provides a method of delivering a content to a user, the method comprising the following steps implemented by a first content-delivery device, referred to as a secondary device:
a step of obtaining at least one quality indicator from the user relating to delivery of a portion of said content to said user by a second content-delivery device, referred to as a primary device;
a step of detecting an event that might affect the delivery of the content by the primary device to the user on the basis at least of quality indicators relating to at least one delivery of content by said primary device; and
a step of sending a command to the user to transfer from the primary device to the secondary device in order to enable the secondary device to deliver portions of said content that have not been delivered by the primary device.
Thus, the content-delivery method enables a drop in quality to be detected on the basis of measurements performed by at least one user to which the content is being delivered from the primary device. This makes it possible to anticipate actions that need to be taken in order to guarantee reception quality for the user. The content-delivery devices may be content-delivery servers. They may also be peers in a peer-to-peer or P2P type network. The user terminal may be a P2P network peer: under such circumstances, it may perform two functions, both terminal and server.

The method is remarkable in that the secondary device is the receiver of the measurements and as a result can take over from the primary device in order to deliver the content. In conventional manner, it is the device or the peer that is delivering the content that receives the measurements performed by the user's terminal. By means of the content-delivery method of an embodiment of the invention, poor user perceptions associated with degraded quality are thus avoided, since the content-delivery method anticipates a forthcoming problem and proposes a solution, instead of responding after the problem has occurred. Thus, there is no need in such circumstances to introduce redundancy by providing a plurality of devices in order to guarantee that the desired quality will be reached. This limits the redundancy needed in the communications network. Furthermore, the processor load on the primary device delivering the content is reduced since it is not involved in collecting the measurements or in analyzing them. It is no longer both judge and judged in making the content-delivery method secure. The secondary device has processor resources available for performing those tasks. Since the path taken through the network between the user and the secondary device is, a priori, different from the path between the user and the primary device, once the session has been transferred from the primary device to the secondary device, the quality of the delivery of the content can only improve. Furthermore, supervising the quality of the delivery of the content is less complex to implement in such an architecture than in a communications network where a plurality of servers or of peers are involved in delivering the content. The supervision of the quality with which a content is delivered thus becomes deterministic and it is controlled by the network. In a network involving a plurality of servers or peers, the supervision and then the decision to change server or peer are generally performed by the terminal itself. Changes of server or of peer by a set of terminals can then give rise to oscillating loads on the links and the servers, and that can prevent the content-delivery service from being provided, even though the nominal loading of the system has not yet been reached.

The delivery method is particularly adapted for implementation in a content-delivery network (CDN) type communications network.

According to a particular characteristic, the event forms part of the group comprising: a reduction of quality affecting the delivery of content by the primary device; a reduction of quality affecting the delivery of content by the primary device to the user; an interruption of data exchange with the primary device; and atypical synthesized data determined by the primary device compared with synthesized data concerning other content-delivery devices.

Thus, a decision to transfer may be taken on various criteria that are determined either for the user in question or for a set of users in communication with the primary device.

According to another particular characteristic, the method further includes a step of obtaining content and a step of delivering some other content prior to the step of delivering the content.

The secondary device is suitable for implementing preliminary steps before delivering content either before or in parallel with sending the transfer command. It may in particular be selected because of ongoing delivery of the same content to other users. Once the user session with the primary device has been transferred, it can then immediately take over in delivering the content, starting delivery from the portions not delivered by the primary device. Under the worst of circumstances, the user then perceives no more than an interruption of short duration in the delivery of the content. It is also possible for the secondary device to insert some other content, such as waiting content.

According to yet another particular characteristic, the transfer command includes a notification of said event to the user.

In this way, the information given to the user is improved.

Correspondingly, an embodiment of the invention also provides a method of a user obtaining a content, the method comprising the following steps implemented by said user:
a step of discovering a first content-delivery device, referred to as a primary device, and a second content-delivery device referred to as a secondary device, both being suitable for delivering said content;
a step of receiving at least a portion of the content from the primary device;
a step of sending at least one quality indicator to the secondary device relating to the delivery of a portion of said content to said user by the primary device; and
a step of receiving a command to transfer from the primary device to the secondary device in order to enable the secondary device to deliver portions of said content that have not been delivered by the primary device.

In a second aspect, an embodiment of the invention provides a device for delivering content to a user, the device comprising:
obtaining means for obtaining at least one quality indicator from the user relating to delivery of a portion of said content to said user by another content-delivery device, referred to as a primary device;
detecting means for detecting an event that might affect the delivery of the content by the primary device to the user, detection being based on quality indicators relating to at least one delivery of content by the primary device; and
control means for controlling the transfer of the user from the primary device to the said device in order to enable said device to deliver portions of said content that have not been delivered by the primary device.

In a third aspect, an embodiment of the invention provides a device for obtaining a content, the device comprising:
discovery means for discovering a first content-delivery device referred to as a primary device, and a second content-delivery device referred to as a secondary device, both devices being suitable for delivering said content;
receiver means for receiving at least a portion of the content from the primary device;
sender means for sending at least one quality indicator to the secondary device relating to the delivery of a portion of said content to said user by the primary device; and
receiver means for receiving a command to transfer from the primary device to the secondary device in order to enable the secondary device to deliver portions of said content that have not been delivered by the primary device.

In a fourth aspect, an embodiment of the invention provides a content-delivery system comprising content-delivery devices and at least one content-obtaining device as described above.

In a fifth aspect, an embodiment of the invention provides a computer program including instructions for implementing the content-delivery method as described above by means of a content-delivery device when the program is executed by a processor.

In a sixth aspect, an embodiment of the invention provides a computer program including instructions for implementing the content-obtaining method as described above by a content-obtaining device when the program is executed by a processor.

### BRIEF DESCRIPTION OF THE DRAWINGS

The disclosure can be better understood with the help of the following description of a particular implementation of the methods of embodiments of the invention, given with reference to the accompanying drawings, in which:

FIG. 1 shows a content-delivery system in its environment in a particular embodiment of the invention;

FIG. 2 is a simplified diagram of the steps of the methods implemented for distributing content in a particular embodiment of the invention;

FIG. 3 shows a content-delivery device in a particular embodiment of the invention;

FIG. 4 shows a content-obtaining device in a particular embodiment of the invention; and

FIG. 5 shows an example of content received by a terminal in a particular embodiment of the invention.

### DETAILED DESCRIPTION OF ILLUSTRATIVE EMBODIMENTS

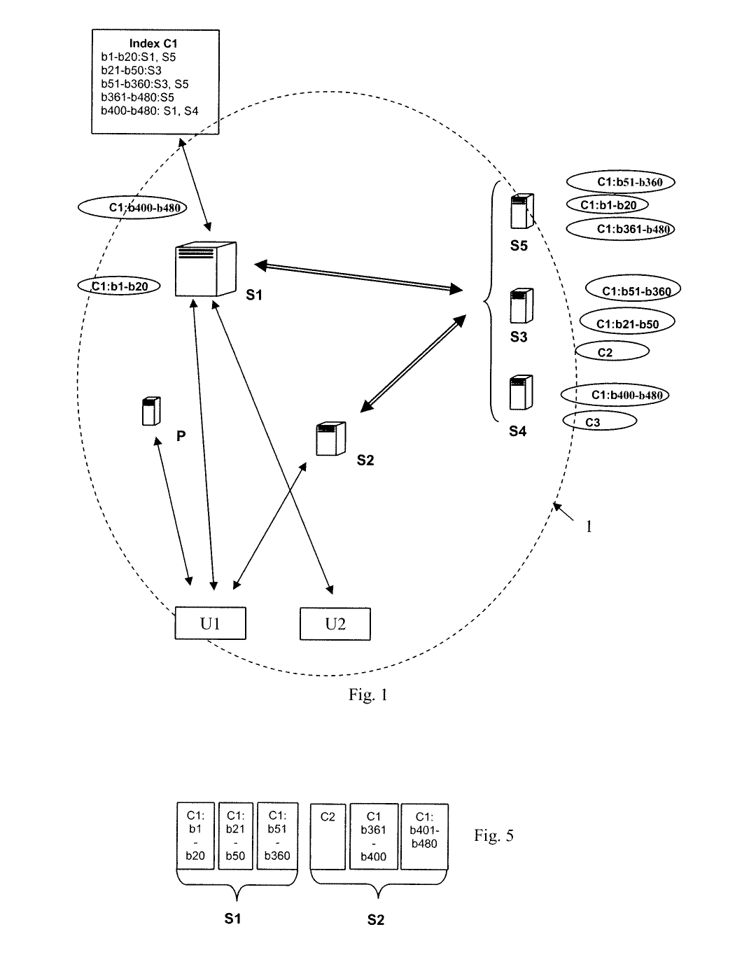

The content-delivery system 1 in its environment is described with reference to FIG. 1 in a particular embodiment.

The content-delivery system 1 comprises a plurality of content-delivery servers, two of which, S1 and S2, are shown in FIG. 1, for distributing content to a plurality of users U1, U2. Below, the same reference is used both for a terminal and for the user of the terminal. The contents for delivery are shared over the content-delivery servers S1 and S2 and content servers S3, S4, S5. The delivery servers S1, S2 and the content servers S3, S4, S5 constitute a portion of a Content Delivery Network. A CDN network is constituted by servers connected as a network via a communications network of the Internet type or any other type of network, e.g. a mobile network. These servers co-operate in order to make multimedia content or data available to users. The servers co-operate with one another in order to satisfy requests issued by users for access to content or to data, and they deliver the content or the data to the users in return. The article “A taxonomy and survey of content-delivery networks” by M. Pathan et al., Technical Report, GRIDS-TR-2007-4, Grid Computing and Distributed Systems Laboratory, The University of Melbourne, Australia, Feb. 12, 2007, sets out the state of the art for this type of network. Naturally, FIG. 1 shows only that portion of the CDN network that is used in the description of this embodiment.

FIG. 1 shows contents C1, C2, C3 by way of indication that are shared over the various servers S1-S5. The contents may be of different types. They may be contents that are broadcast in real time, multimedia contents suitable for being obtained on demand, multimedia contents suitable for being broadcast in continuous reading or “streaming” mode, news contents in the “really simple syndication” (RSS) format, multimedia books, . . . . Below, it is assumed that the contents are subdivided into unit blocks. A content may be shared over different servers. A block number of the content serves to identify a given block of the content. An index block “Index C1” serves to obtain information about the location of the data blocks on the various servers. For example, for the content C1, the index block indicates that the data blocks b1 to b20 are available on the servers S1 and S5, the blocks b21 to b50 on the server S3, and the blocks b51 to b360 on the servers S3 and S5, the blocks b361 to b480 on the server S5, and the blocks b400 to b480 on the servers S1 and S4.

The content-delivery server S1 has the blocks b1 to b20 and the blocks b400 to b480 of the content C1. The content server S3 has the blocks b21 to b50 and the blocks b51 to b360 of the content C1, and the content C2. The content server S4 has the blocks b400 to b480 of the content C1, and the content C3. The content server S5 has the blocks b1 to b20, the blocks b51 to b360, and the blocks b361 to b480 of the content C1.

It is emphasized here that the distribution of the contents and of the data blocks is given purely by way of example for illustrating the implementation of the methods of selecting content, delivering content, and obtaining content.

FIG. 1 also shows a catalog server P, offering users U1, U2 various contents C1, C3 in a catalog C.

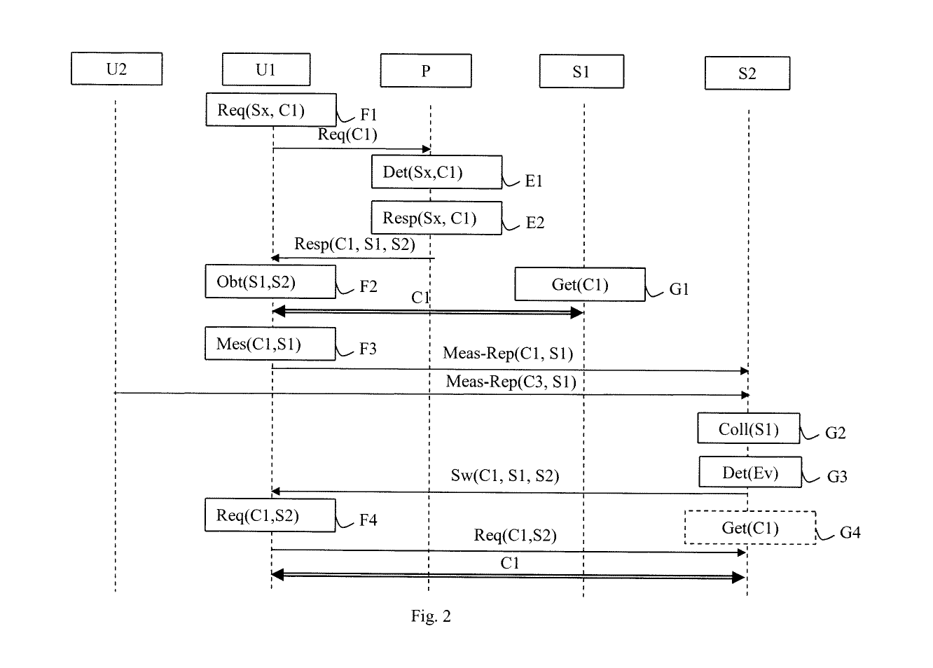

The various steps of methods implementing embodiments of the invention, i.e. the selection method implemented by a catalog server, the content-delivery method implemented by a content-delivery server, and the method of obtaining content by a terminal in a particular implementation of the invention are described below with reference to FIG. 2. It should be observed that not all of the steps are shown in FIG. 2 in order to avoid making it excessively complicated.

In a step F1 of the method of obtaining content, the user U1 requests the delivery of content C1 from the catalog server P by means of a message Req(C1). The request Req(C1) is received by the catalog server P in a step E1 of the selection method. Still in this step E1, the catalog server P determines which servers are suitable for delivering the content C1. A server is said to be “suitable for delivering content” when a server has good availability conditions, good loading conditions, or is situated close to the terminal requesting content delivery. In a step E2 of the selection method, the catalog server P sends a response Resp(C1,S1,S2) to the user U1, the response containing the address of the server S1, said to be a “primary” server, and a URL content address of the content C1 in the communications network, where URL stands for “uniform resource locator”. The response Resp(C1,S1,S2) also includes a command to enable the terminal U1 to send quality indicators to the server S2, referred to as a “secondary” server, the quality indicators relating to the delivery of the content C1 by the primary server S1. It should be observed that the server S2 forms part of the content delivery servers that are suitable for delivering the content C1. For example, the server S2 may be in the process of delivering the content C1 to another user.

Consideration is given below to the particular circumstances in which the quality indicator transmission command comprises a program that is interpretable by the terminal of the user U1, e.g. in the form of AJAX code, where AJAX stands for “asynchronous JavaScript and XML”, containing software instructions for transmitting quality indicators or measurements to the server S2 about the delivery of the content C1 to the user U1 by the primary server S1.

In a step F2 of the method of obtaining content C1, the user U1 obtains the response Resp(C1,S1,S2) from the catalog server P. The user U1 thus discovers two servers S1 and S2 suitable for delivering the content.

In a step G1 of the delivery method, the primary server S1 obtains the content C1 from the CDN network by consulting the index block of the content C1 and then from the content servers. This step G1 is not described in greater detail since it implements mechanisms that are conventional in CDN type networks.

Thereafter, the user U1 obtains sets of data blocks of the content C1, with this obtaining stage being represented in FIG. 2 by a double-line arrow between the user U1 and the primary server S1.

In a step F3 of the obtaining method, the user U1 determines quality indicators, also known as performance indicators, relating to the delivery of a set of data blocks of the content C1. The term “quality indicator” is used to cover a measurement performed by the user U1 after a set of blocks have been delivered. It may relate to quality that is measured or quality that is perceived by the user U1. By way of example, such quality indicators include a number for lost packets, a measure of jitter, a delay, a mean opinion score (MOS) for the audio or video contents, a change in data rate over the link between the primary server S1 and the user U1, an indicator representative of the processor load on the terminal U1, an indicator representative of the availability of memory in the terminal U1, . . . . By way of example, such quality indicators may be collected in a real time transport (RTP) connection and transmitted in RTP control protocol extended report (RTCP XR) messages. The indicators may also be collected for a streaming session and sent in multimedia session control messages, e.g. in real time streaming protocol (RTSP). Under such circumstances, the indicators are generally put into XML blocks in the World Wide Web Consortium (W3C) extended log format.

Still during this step F3, the user U1 sends a measurement report Meas-Rep(C1,S1) to the secondary server S2 as specified in the response Resp(C1,S1,S2), this report containing a session identifier, an identifier of the content C1, an identifier of the primary server S1, a current block number, and the determined quality indicators. This measurement report may be transmitted using a hypertext message protocol such as hypertext transfer protocol (HTTP), e.g. a GET message. The identifier of the session serves to group together the various measurement reports relating to a single session.

The message Meas-Rep(C1,S1) is received by the secondary server S2 in a step G2. It should be observed that the server to which the measurement reports are sent is not the server in charge of delivering the content C1 to the user U1. The secondary server S2 is available for receiving and processing the measurement reports. The supervision of content delivery is thus particularly simple to put into place.

In the implementation described herein, the secondary server S2 acts in this step G2 to aggregate the received quality indicators with quality indicators relating to the delivery of the content C1 to the user U1 and with quality indicators relating to the deliveries of content by the primary server S1. As shown in FIG. 2, the secondary server S2 also receives quality indicators Meas-Rep(C3,S1) relating to the delivery of content C3 by the primary server Si to the user U2. It should be observed that the secondary server S2 also receives quality indicators for sessions between users and servers other than the primary server S1. The secondary server S2 is thus an element of a distributed surveillance system in which each server delivers content to client and monitors some of the sessions of each of the other servers. The secondary server S2 thus has data available for determining metadata or synthesized data representative of the activity of the content-delivery service. By way of example, the metadata may give the number of servers involved in providing the service, a value representative of the activity of the service as determined from variation in the number of sessions over time, the relative load of the servers compared with one another, a value representative of the general operation of the service, a value representative of operation of each server, a general quality of service (QoS) value for the network as determined from packet loss rate, delays, and jitter, and a quality of experience (QoE) value provided by each server on the basis of packet loss rate, delays, and jitter.

FIG. 2 shows only one measurement report being sent in order to avoid complexifying FIG. 2. Naturally, these measurement reports are sent regularly by the terminal U1 and the secondary server S2 reiterates the step G2 on receiving new measurement reports.

On the basis of these quality indicators that are aggregated at various levels, at user level or at primary server level, the secondary server S2 detects an event in a step G3. The event may be a decrease in quality relating to the primary server S1, a decrease in quality relating to the delivery of the content C1 to the user U1, an interruption of data exchanges with the primary server S1, atypical metadata describing the operation of the primary server S1 as compared with the other servers. As an example of atypical metadata, mention may be made of a jitter value that is ten times greater on the session between the user U1 and the primary server S1 than on other sessions. Such a jitter value is representative of the primary server S1 being overloaded. Under such circumstances, the data relating to the sessions spends, on average, longer in the queues, thereby making the delay between an application processing the data and the data being sent over the network very variable. Naturally, this list is not exhaustive.

When the event is detecting a reduction in quality concerning the delivery of the content C1 to the user U1 or detecting an interruption of data exchange between the user U1 and the primary server S1, the secondary server S2 acts in a step G3 to send a command SW(C1,S1,S2) to the user U1 for transferring the session or the context from the primary server S1 to the secondary server S2.

When the event is detecting a reduction in quality relating to the primary server S1, the secondary server S2 acts in a step G3 to send a command SW(Cx,S1,S2) to all of the users U1 U2 that have sent quality indicators relating to the delivery of any content by the primary server S1, which command is for switching their respective sessions or contexts from the primary server S1 to the secondary server S2.

When the event is detecting atypical metadata describing the operation of the primary server S1 in comparison with the other servers, the secondary server S2 acts in a step G3 to send either a command to one of the users or else a command to a group of users so as to reduce the load on the primary server S1.

More precisely, in these various situations, the transfer command SW(C1,S1,S2) is a command for redirecting to the secondary server S2 the session or context that the user U1 has established with the primary server S1 for delivering the content C1.

In parallel, if the secondary server S2 does not have the content C1 available, it obtains the content C1 in step G4 of the content-delivery method in a manner similar to the step G1 of the same method.

The transfer command is received by the user U1 in a step F4 of the content-obtaining method. The processing to be performed by the terminal U1 on receiving this transfer command may also be included in the AJAX code received during the step F2 of the content-obtaining method. Still in this step F4, the user U1 transfers the session that has been established with the primary server S1 for delivery of the content C1 to the secondary server S2.

The broadcasting of the content C1 may restart from the secondary server S2 to the user U1 from the current block number contained in the most recent measurement report to be sent. The broadcasting of the content C1 may restart immediately, or possibly after broadcasting waiting content C2. Thus, it is possible to anticipate the appearance of a degradation in quality as felt by the user and to switch the session to a secondary server that is itself ready to take over. The user does not perceive any degradation in quality and obtains the looked-for content, possibly from both servers. At any given instant, only two servers are involved in delivering content to a user and in supervising the delivery of the content, thereby limiting the number of servers that are involved. The secondary server S2 has processor resources for supervising the quality with which the content C1 is delivered. Use is also made of measurement reports sent by other users in order to detect a general problem that might affect the primary server S1.

The above description relates to a CDN type network. The method is equally applicable to any Internet type communications network.

More generally, the primary and secondary servers S1 and S2 are distribution delivery devices. The terminal U1 may, under some circumstances, perform the role of a content-delivery server.

For example, the terminal U1 may be a peer in a P2P type network. Under such circumstances, the terminal acts both as a terminal and as a content-delivery server.

Still by way of example, the primary content-delivery device S1 is a server, and the secondary content-delivery device S2 is a peer in a P2P network.

The presence of the catalog server P is optional: content catalogs, e.g. of the “Internet Media Guide” type are available in numerous ways. In particular they may be broadcast on line together with other content.

In a particular implementation, messages are exchanged in the form of web service type requests, as specified by the W3C in its WSDL specification. Message exchanges take place in the form of calls to functions or procedures that are coded in XML.

In a particular implementation, the user U1 discovers the two servers S1 and S2 suitable for delivering the content by using a network address allocation service such as the dynamic host configuration protocol (DHCP) or a service for resolving URLs, such as the domain name system (DNS). In this particular implementation, the catalog server P is not present.

In a particular implementation, the executable program may be installed on initialization or it may be downloaded to the terminal U1. Under such circumstances, the response Resp(C1,S1,S2) contains an identifier of the content C1, an identifier of the content-delivery server S1, acting as a primary server, and an identifier of the content-delivery server S2, acting as a secondary server.

It is also possible to make provision in the transfer command for an identifier of a third content-delivery server (not shown in FIG. 1) to which the measurement reports are sent after they have been transferred to the secondary server S2, with the secondary server then becoming a primary server in turn.

The transfer command may further include a notification of the detected event sent to the user U1. This enables the user to be informed about the ongoing transfer, thereby improving the user's information.

In a variant of the above-described implementation, the server S2 acts during the step G2 to store the aggregated quality indicators that it has determined in a database (not shown in FIG. 1). The database is used by the catalog server P during the step E1 of the selection method to determine the content-delivery servers S1-S2 that are suitable for delivering the content C1. It is thus possible to select content-delivery servers suitable for delivering the content C1 as a function of quality indicators that have been observed during earlier content deliveries.

The content C1 as received by the terminal U1 is represented diagrammatically in FIG. 5. The blocks b1 to b360 were received from the primary server S1, and then transfer took place. The terminal U1 then received the content C2 from the secondary server S2, as waiting content, and then the delivery of the content C1 restarted from data block b361 up to data block b480. Naturally, the waiting content C2 is optional.

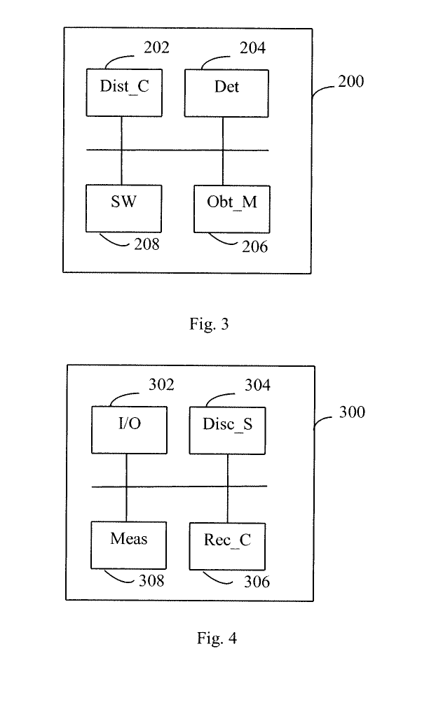

There follows a description of a content-delivery device 200 in a particular embodiment, and with reference to FIG. 3.

The content-delivery device 200 comprises:
a module 202 for delivering content to users;
a module 206 for obtaining from a user at least one quality indicator relating to delivery of a portion of said content to said user by some other content-delivery device, referred to as a primary device;
a module 204 for detecting an event that might affect the delivery of the content by the primary device to the user on the basis of quality indicators relating to at least one delivery of content by the primary device; and
a module 208 for controlling the transfer from the user of the primary device to said device 200 in order to enable said device 200 to deliver portions of said content that have not been delivered by the primary device.

The module 206 is also arranged to aggregate the quality indicators it receives with quality indicators relating to the delivery of a content to the user and with quality indicators relating to the deliveries of content by the primary device.

The content-delivery device 200 is designed to be incorporated in content-delivery servers S1, S2.

In some of the above-described embodiments, in particular when the user terminal U1 acts as a content-delivery server, the content-delivery device 200 may be incorporated in a terminal U1.

There follows a description of a content-obtaining device 300 in a particular embodiment, given with reference to FIG. 4.

Such a content-obtaining device 300 comprises:
a module 304 for discovering a first content-delivery device, referred to as a primary device, and a second content-delivery device, referred to as a secondary device, and suitable for delivering said content;
a module 306 for receiving at least a portion of the content from the primary device;
a module 308 for determining at least one quality indicator relating to the delivery of a portion of said content to said user by the primary device; and
a send and receive module 302 arranged to send at least one determined quality indicator and to receive a command to transfer from the primary device to the secondary device in order to enable the secondary device to deliver portions of said content that have not been delivered by the primary device.

In an embodiment, the module 304 is arranged to request a delivery of the content C1 from a catalog server P and to obtain a response in return having the address of the primary address S1, a URL content address of the content C1 in the communications networks, and a request for transmitting quality indicators to the secondary device S2 about the delivery of the content C1 by the primary device S1.

The content-obtaining device 300 is designed to be incorporated in the user terminal U1.

The modules 202, 204, 206, and 208 of the content-delivery device 200 are arranged to implement the steps of the above-described content-delivery method when executed by the content-delivery device. These are preferably software modules comprising software instructions for executing those steps of the above-described delivery method that are implemented by a content-delivery device.

An embodiment of the invention thus also provides:
a program for a content-delivery device, the program including program instructions for controlling the execution of those steps of the above-described delivery method that are executed by the device when said program is executed on a processor thereof; and
a recording medium readable by a content-delivery device and having recorded thereon the program for the content-delivery device.

The modules 302, 304, 306, and 308 of the content-obtaining device 300 are arranged to implement the steps of the above-described content-obtaining method that are executed by the content-obtaining device. These are preferably software modules including software instructions for causing those of the steps of the above-described obtaining method that are implemented by a content-obtaining device to be executed thereby.

An embodiment of the invention thus also provides:
a program for a content-obtaining device, the program including program instructions for controlling the execution of steps of the above-described content-obtaining method that are executed by said device, when said program is executed by a processor thereof; and
a recording medium readable by a content-obtaining device and having recorded thereon the program for the content-obtaining device.

The software modules may be stored in or transmitted by a data medium. The data medium may be a hardware storage medium, e.g. a compact disk read-only memory (CD-ROM), a magnetic floppy disk, or a hard disk, or indeed a transmission medium such as an electrical, optical, or radio signal, or a telecommunications network.

An embodiment of the invention also provides a content-delivery system 1 having content-delivery devices and at least one content-obtaining device, as described above.

Although the present disclosure has been described with reference to one or more examples, workers skilled in the art will recognize that changes may be made in form and detail without departing from the scope of the disclosure and/or the appended claims.

1. A method of delivering content to a user, the method comprising the following steps implemented by a first content-delivery device, referred to as a secondary device:
a step of obtaining at least one quality indicator from the user relating to delivery of a portion of said content to said user by a second content-delivery device, referred to as a primary device;
a step of detecting an event that might affect the delivery of the said content by the primary device to the user on the basis at least of quality indicators relating to at least one delivery of said content by said primary device; and
a step (G3) of sending a command to the user to transfer from the primary device to the secondary device in order to enable the secondary device to deliver portions of said content that have not been delivered by the primary device.

2. The method according to claim 1, wherein the event forms part of the group consisting of: a reduction of quality affecting the delivery of content by the primary device; a reduction of quality affecting the delivery of content by the primary device to the user; an interruption of data exchange with the primary device; and atypical synthesized data determined by the primary device compared with synthesized data concerning other content-delivery devices.

3. The method according to claim 1, further including a step of obtaining said content and a step of delivering some other content prior to the step of delivering said content.

4. The method according to claim 1, wherein the transfer command includes a notification of said event to the user.

5. A method of a user obtaining content, the method comprising the following steps implemented by said user:
a step of discovering a first content-delivery device, referred to as a primary device, and a second content-delivery device referred to as a secondary device, both being suitable for delivering said content;
a step of receiving at least a portion of the said content from the primary device;
a step of sending at least one quality indicator to the secondary device relating to the delivery of a portion of said content to said user by the primary device; and
a step of receiving a command to transfer from the primary device to the secondary device in order to enable the secondary device to deliver portions of said content that have not been delivered by the primary device.

6. A device for delivering content to a user, the device comprising:
obtaining means for obtaining at least one quality indicator from the user relating to delivery of a portion of said content to said user by another content-delivery device, referred to as a primary device;
detecting means for detecting an event that might affect the delivery of the said content by the primary device to the user, detection being based on quality indicators relating to at least one delivery of said content by the primary device; and
control means for controlling the transfer of the user from the primary device to the said device in order to enable said device to deliver portions of said content that have not been delivered by the primary device.

7. A device for obtaining a-content, the device comprising:
discovery means for discovering a first content-delivery device referred to as a primary device, and a second content-delivery device referred to as a secondary device, both devices being suitable for delivering said content;
receiver means for receiving at least a portion of said content from the primary device;
sender means for sending at least one quality indicator to the secondary device relating to the delivery of a portion of said content to said user by the primary device; and
receiver means for receiving a command to transfer from the primary device to the secondary device in order to enable the secondary device to deliver portions of said content that have not been delivered by the primary device.

8. A content-delivery system comprising:
a first content delivery device, referred to as a secondary device, for delivering content to a user, comprising:
obtaining means for obtaining at least one quality indicator from the user relating to delivery of a portion of said content to said user by a second content-delivery device, referred to as a primary device;
detecting means for detecting an event that might affect the delivery of said content by the primary device to the user, detection being based on quality indicators relating to at least one delivery of said content by the primary device; and
control means for controlling the transfer of the user from the primary device to the secondary device in order to enable the secondary device to deliver portions of said content that have not been delivered by the primary device; and
a content-obtaining device for obtaining the content, comprising:
discovery means for discovering the primary and secondary devices;
receiver means for receiving at least a portion of said content from the primary device:
sender means for sending said at least one quality indicator to the secondary device; and
receiver means for receiving a command to transfer the user from the primary device to the secondary device in order to enable the secondary device to deliver said portions of the content that have not been delivered by the primary device.

9. A computer program recorded on a hardware storage medium including instructions for implementing a method of delivering content to a user by a first content-delivery device, referred to as a secondary device, when said program is executed by a processor, the method comprising:
a step of obtaining at least one quality indicator from the user relating to delivery of a portion of said content to said user by a second content-delivery device, referred to as a primary device;
a step of detecting an event that might affect the delivery of said content by the primary device to the user on the basis at least of quality indicators relating to at least one delivery of said content by said primary device; and
a step of sending a command to the user to transfer from the primary device to the secondary device in order to enable the secondary device to deliver portions of said content that have not been delivered by the primary device.

10. A computer program recorded on a hardware storage medium including instructions for implementing a method of a user obtaining content by a content-obtaining device when said program is executed by a processor, the method comprising:
a step of discovering a first content-delivery device, referred to as a primary device, and a second content-delivery device referred to as a secondary device, both being suitable for delivering said content;
a step of receiving at least a portion of said content from the primary device;
a step of sending at least one quality indicator to the secondary device relating to the delivery of a portion of said content to said user by the primary device; and
a step of receiving a command to transfer from the primary device to the secondary device in order to enable the secondary device to deliver portions of said content that have not been delivered by the primary device.
